(19) United States
(12) Patent Application Publication
(10) Pub. No.: US 2026/0028917 A1
(43) Pub. Date: Jan. 29, 2026

(54) METHOD FOR MANAGING POWER TRANSITIONS BETWEEN A GENERATION MODE AND AN ASSISTANCE MODE

(71) Applicant: SAFRAN, Paris (FR)

(72) Inventors: Meriem ABDELLATIF, Moissy-Cramayel (FR); Florent Jean-Arnaud ROUGIER, Moissy-Cramayel (FR); Guillaume François Daniel BIDAN, Moissy-Cramayel (FR); Anne Marie LIENHARDT, Moissy-Cramayel (FR)

(73) Assignee: SAFRAN, Paris (FR)

(21) Appl. No.: 19/139,120

(22) PCT Filed: Dec. 12, 2023
(86) PCT No.: PCT/FR2023/051992

§ 371 Date: Jun. 13, 2025

(30) Foreign Application Priority Data
Dec. 16, 2022 (FR) FR2213644

(51) Int. Cl. F01D 15/10; F02C 6/00

(52) U.S. Cl. CPC F01D 15/10; F02C 6/00; F05D 2220/323; F05D 2220/7642

(57) ABSTRACT

A method for a turbomachine having a high-pressure shaft driving a high-pressure electric machine and from which a high-pressure power taken off and a low-pressure shaft driving a low-pressure electric machine and from which a low-pressure power is taken off, the generation mode corresponding to a predetermined sharing of power between the high-pressure power and the low-pressure power and the assistance mode corresponding to a request for injection of an additional power into the high-pressure shaft or the low-pressure shaft, a method in which, to reach the requested additional power, when the high- or low-pressure power takeoff is interrupted and the high- or low-pressure electric machine respectively driving the high- or low-pressure shaft whose takeoff is interrupted enters motor mode.

### TECHNICAL FIELD

This invention relates to the field of internal hybridization of more electrical or even highly electrified aircraft turbomachines.

### PRIOR ART

Climate change is a major concern for many legislative and regulatory bodies throughout the world. Specifically, various restrictions on carbon emissions have been, are being or will be adopted by various states. In particular, one ambitious standard is applicable both to the new types of aircraft and also those currently in circulation, requiring the implementation of technological solutions to make them compliant with the regulations in effect. For several years now civil aviation has been committed to making a contribution to the combat against climate change.

Technology research efforts have already made it possible to very significantly improve the environmental performance of aircraft. The Applicant takes into consideration the factors affecting all design and development phases, to obtain aerospace components and substances that consume less energy, are more environmentally friendly, and whose integration and use in civil aviation have moderate environmental impacts, with the aim of improving the energy efficiency of these aircraft.

As a consequence, the Applicant is working constantly to reduce its climate impact by the use of methods and the exploitation of virtuous development and manufacturing processes that keep greenhouse gas emissions to a minimum to reduce the environmental footprint of its activity.

This sustained research and development work relates both to the new generations of aircraft turbomachines, the lightening of aircraft, particularly via the materials used and lighter onboard equipment, the development of the use of electrical technology to provide propulsion, and, as essential companions to technological progress, aeronautical biofuels.

Turbomachine hybridization is done by an electrical system forming the interface between the mechanical shafts of the turbomachine and the electrical network of the aircraft.

This system must make it possible to fulfil the start-up functions of the turbomachine (HP and/or LP), the generation of controlled electric power to supply the propulsive and non-propulsive loads and the injection, but also the takeoff of power in a controlled way on the shafts of the turbomachine during the operation of the turbomachine in assistance mode. The balance between the power consumed by the loads and the power generated by the available sources is ensured by controlling the voltage of the buses (in terms of frequency and maximum amplitude for AC voltage and in terms of amplitude for DC voltage), while complying with the restrictions of the system.

More precisely, when the turbomachine requires assistance, a source which participates in the regulation of the generation voltage stops participating in the generation and enters motor mode. This switch of operating mode causes a sharp fluctuation in the voltage which then moves away from the predefined voltage envelopes (FIG. 5) defining limits that must not be exceeded, both in the transient and steady states for both normal 500 operation and abnormal operation (with a problem on the network, i.e. short circuit) 502 of the turbomachine.

To control this voltage and keep it within these envelopes, it is known practice to have recourse either to load shedding (for example non-priority loads) by temporarily reconfiguring the electrical system, or to an external source (associated with temporary load shedding or not) having a greater dynamic range than that of the sources of the turbomachine to supply the high-frequency (HF) part of the power to be generated, or else to an over-dimensioning of certain passive members of the electrical system such as the capacitors of the power electronics.

Nonetheless, these solutions are not without their drawbacks. Load shedding does not include any anticipation of the power consumption or the behavior of the electrical network and the addition of an external source is based solely on the frequency sharing of the power generated between the turbomachine and this external source, the turbomachine only ever supplying an average power. Finally, the over-dimensioning of the systems has a mass penalty and is hence hardly desirable for an aerospace application.

### SUMMARY OF THE INVENTION

For this purpose, the invention is the result of technology research with the aim of very significantly improving aircraft performance and, in this sense, contributes to the reduction of the environmental impact of these aircraft. To do so, this invention thus has the main aim of limiting sharp fluctuations in voltage when the turbomachine enters assistance mode, anticipating the sudden variation in the available power and without any onboard mass penalty, while complying with the quality restrictions of the electrical network.

These aims are achieved by a method for managing the power transitions between a generation mode and an assistance mode in a turbomachine having a high-pressure shaft driving a high-pressure electric machine and from which a high-pressure power is taken off and a low-pressure shaft driving a low-pressure electric machine and from which a low-pressure power is taken off, the generation mode corresponding to a predetermined sharing of power between the high-pressure power and the low-pressure power and the assistance mode corresponding to a request for injection of an additional power into the high-pressure shaft or the low-pressure shaft, characterized in that to reach the requested additional power, when the high- or low-pressure power takeoff is interrupted and the high- or low-pressure electric machine respectively driving the high- or low-pressure shaft whose takeoff is interrupted enters motor mode, the remaining taken-off power from the high- or low-pressure shaft in generator mode is adjusted based on the injected high- or low-pressure power coming from the high- or low-pressure electric machine that has entered motor mode.

Thus, by sending to the source that is in generation mode the power requested by the source that enters assistance mode, this request is anticipated, the voltage variation is limited and the transient response is controlled while containing the voltage within the defined envelopes.

Preferably, if the high- or low-pressure electric machines have different dynamic ranges, the injection of the requested additional power is done by adapting the dynamic range of the takeoff of the remaining taken-off high- or low-pressure power.

The invention also relates to a turbomachine having a high-pressure shaft from which a high-pressure power is taken off and a low-pressure shaft from which a low-pressure power is taken off, a control module receiving power setpoints from an ECU and power converters associated with high- and low-pressure electric machines respectively mounted on the high- and low-pressure shafts, a generation mode corresponding to a predetermined sharing of power between the high-pressure power and the low-pressure power and an assistance mode corresponding to the injection of an additional power into the high-pressure shaft or the low-pressure shaft, characterized in that to reach the requested additional power, the control module is configured so that, when the takeoff of high- or low-pressure power is interrupted and the high- or low-pressure electric machine respectively driving the high- or low-pressure shaft whose takeoff is interrupted enters motor mode, the remaining taken-off power from the high- or low-pressure shaft in generator mode is adjusted based on the injected high-pressure or low-pressure power coming from the high-pressure or low-pressure electric machine that has entered motor mode.

Preferably, the control module further comprises assistance modules configured to add the injected high- or low-pressure power to the remaining taken-off high- or low-pressure power and a selecting module configured to select the taken-off powers coming from the assistance modules.

Advantageously, each of the assistance modules includes an adder and an adapting module having a transfer function F1, F2 to adapt the dynamic range of the remaining taken-off high- or low-pressure power according to the respective dynamic ranges of the high- and low-pressure electric machines.

According to the dynamic range of the electric machines, the transfer functions are equal to 1 if the high- and low-pressure electric machines have the same dynamic range, are phase delays if the dynamic range of the electric machine that enters motor mode is slower than the one that remains in generator mode, or are phase advance functions if the dynamic range of the electric machine that enters motor mode is faster than the one that remains in generator mode.

### BRIEF DESCRIPTION OF THE DRAWINGS

Other features and advantages of this invention will become apparent from the description given below, with reference to the appended drawings which illustrate an exemplary embodiment thereof without any limitation and on which:

FIG. 1 illustrates an architecture of an internal hybridization system of a turbomachine in accordance with the invention,

FIG. 2 details the innovative control module of the internal hybridization system of FIG. 1,

FIG. 3 illustrates the takeoff setpoints of the powers associated with a request for assistance,

FIG. 4 shows the different steps of the method implemented in the internal hybridization system of FIG. 1, and

FIG. 5 shows an example of voltage envelopes applicable to the internal hybridization system of FIG. 1.

### DESCRIPTION OF THE EMBODIMENTS

When there is a request for assistance, an electrical source of the turbomachine which participates in the regulation of the generation voltage ceases to do so and enters motor mode to inject the necessary power and provide the function of assistance of the turbomachine. Since the remaining sources have a certain response time, the time they take to reconfigure to supply the lacking power, the generation voltage greatly decreases and goes outside the limits of the imposed envelopes, especially as the balance between generated power and consumed power is no longer maintained.

To remedy this problem, the invention proposes to act on the control module of the remaining sources to modify the behavior thereof after the request for assistance of the turbomachine, such that the transient response of the generation voltage remains contained within the predefined envelopes.

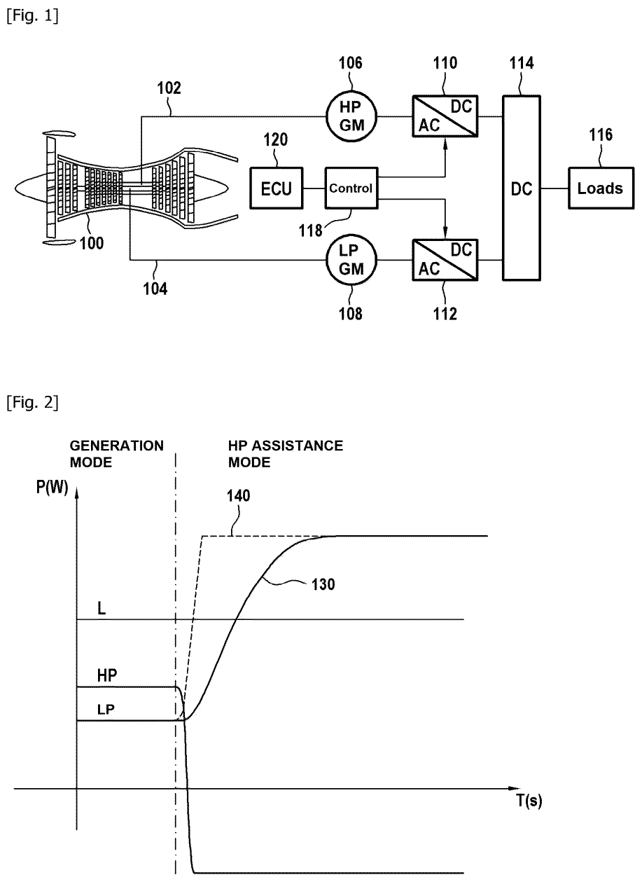

FIG. 1 illustrates an example of an architecture of the internal hybridization systems of a turbomachine 100 based on DC channels connected in parallel, typically an HP channel (corresponding to the high-pressure shaft 102 of the turbomachine) and an LP channel (corresponding to its low-pressure shaft 104). These two DC channels are each operated by an electric machine 106, 108, typically a permanent-magnet synchronous machine, associated with a controlled AC-DC reversible power converter 110, 112 delivering a DC voltage to a DC busbar 114 connected to the loads 116 to be supplied (propulsive or non-propulsive). The control of the reversible power converters is conventionally provided by a control module 118 which receives its orders from the controller of the turbomachine ECU (Electronic Control Unit) 120 which controls the combustion engine and therefore has, in particular, the function of adapting the percentages of participation of the electric machines to the generation of power to optimize the operating point of the turbomachine.

To do so, the ECU 120 will ask the control module 118 to share the takeoff powers between the HP and LP shafts to supply the loads 116 which consume a power L of the network which generally exhibit dynamic range behavior that can be variable, particularly the so-called active loads.

As shown in FIG. 2, this predetermined sharing of the takeoff powers between the HP and LP shafts requested by the ECU which, for example, is initially in a generation mode in which 60% of the power L is taken off the HP shaft and 40% of the power L is taken off the LP shaft, can, to reach the additional power that the assistance request requires, enter an assistance mode in which the high-pressure power takeoff from the HP shaft is interrupted, the high-pressure electric machine entering motor mode to inject the high-pressure power, and 100% of the power L then being supplied by the LP shaft plus the load requested by the HP shaft, as illustrated on this figure.

However, on entering the assistance mode, due to this instantaneous modification of the power ratio, the power supplied in the transient state 130 and the desired power 140 diverge. It is therefore a question of finding the means of compensating for the difference between the power supplied in the transient state by the remaining sources and the desired power to contain the generation voltage within the predefined envelopes until steady state is reached without the addition of any external source.

More explicitly, this power difference in the transient state is expressed by the following equation (1):

$${W}_{c} = \frac{1}{2} C * {V}^{2} = {\int }_{0}^{t} ( Ps ( t ) - Pl ( t ) ) dt + {W}_{0} \qquad ( 1 )$$

So again by

$${V}^{2} = \frac{2}{c} {\int }_{0}^{t} ( Ps ( t ) - Pl ( t ) ) dt + {V}_{0}^{2} \qquad ( 2 )$$

### With

C—value of the power capacitors on the DC bus
Ps—power of the sources
Pl—power of the loads
Wc—energy in the power capacitors

As it is not possible to envision increasing the size of the capacitors of the power electronics, which would incur an over-dimensioning of the system, or to accelerate the voltage and current control loops, which would involve restrictions on the control line (ECU cycle time, command delays, speeds of the power electronics etc.,), the invention makes provision for an addition of functions in the control module 118 providing the regulation of the generation voltage in order to limit its variation during requests for assistance of the turbomachine and to keep it within the variation ranges defined by the envelopes. The mass is thus optimized since there is no addition of any external source or over-dimensioning of the capacitors of the power electronics in charge of storing up electrical energy.

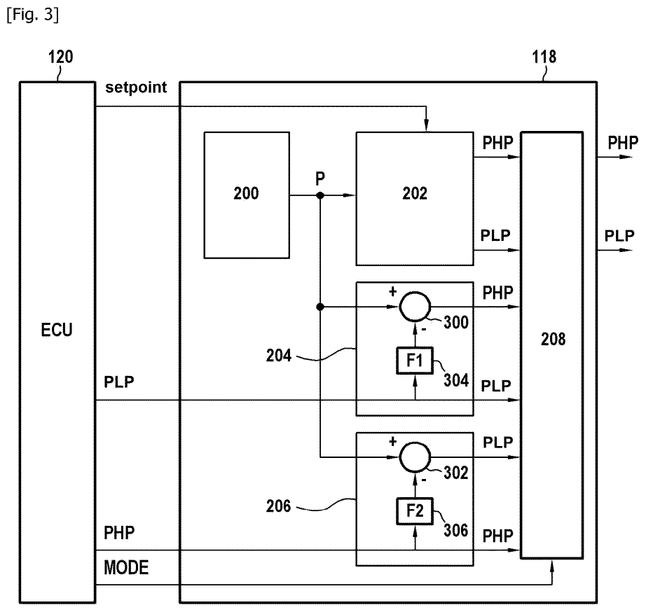

FIG. 3 details the components forming the control module 118 thus modified which further comprises a voltage regulation module 200 delivering the predefined voltage envelopes or the power P needed to guarantee them, a mode generation module 202 to which it is connected and which receives the power setpoints of the ECU 120 and coordinates the sharing of the powers of the load L between the HP and LP shafts, two assistance modules associated, one 204 with the high-pressure shaft and the other 206 with the low-pressure shaft and configured to add the low-pressure P_{LP} or high-pressure P_{HP} injected power to the remaining high-pressure P_{HP} or low-pressure P_{LP} takeoff power respectively, and a selecting module 208 configured to select the taken-off powers P_{LP} and P_{HP} coming from the mode generation module or from the assistance modules based on the power MODE coming from the ECU 120. Each of the assistance modules includes an adder 300, 302 to quantify the powers to be additionally generated on one side and to be taken off on the other side and an adapting module 304, 306 having a transfer function F1, F2 which depends on the dynamic range of the associated electric machine.

For example, if the ECU requests a negative power (P_{LP} in motor mode) from the LP shaft then, for the computation of P_{HP}, the adder subtracts this negative power P_{LP} from the input power P to the assistance module 204, i.e. 100% of the power of the loads since P_{LP} has entered motor mode. At the output P_{HP} is equal to P+P_{LP}.

The transfer functions F1 and F2 serve to adapt the dynamic range of the power taken off from the remaining machine to the dynamic range of the machine that has entered motor mode in order to anticipate its power requirement. According to the situation, F1 and F2 can be equal to:
unity if the two machines installed on the HP shaft and the LP shaft have the same dynamic range,
a phase delay, or any function making it possible to slow down the response of the remaining machine, for example a first-order transfer function, if the dynamic range of the machine that enters motor mode is slower than the machine that remains in generator mode,
a phase advance function, if the dynamic range of the machine that enters motor mode is faster than the remaining machine.

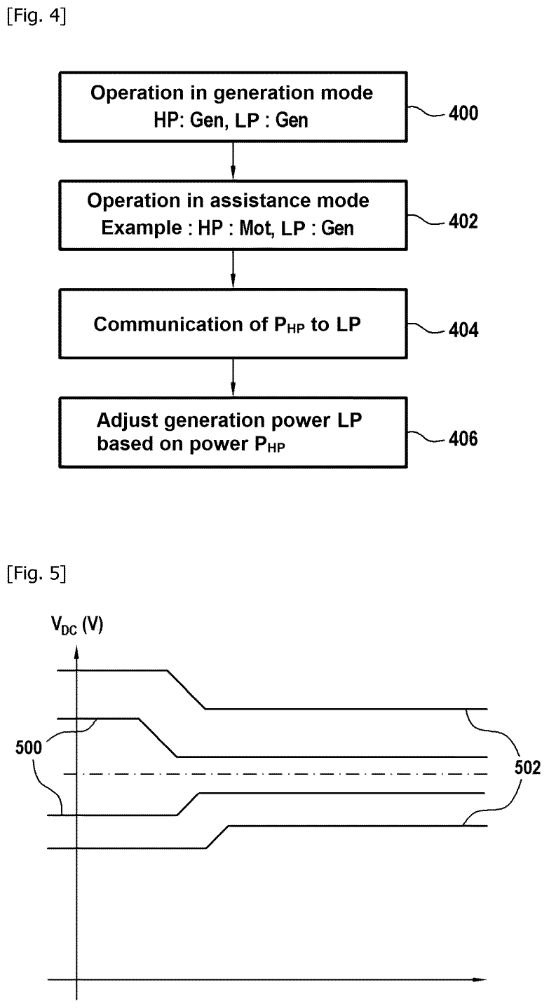

FIG. 4 illustrates the different steps of the method implemented in the control module.

In a first step 400, the system in a normal operating state in generation mode with a sharing of the powers taken off between the high-pressure shaft and the low-pressure shaft. In the following step 402, a request for operating in assistance mode is made and, for example, the high-pressure electric machine (i.e. the one driving the high-pressure shaft) which was in generator mode in the normal operation mode (which is interrupted) enters motor mode. In a new step 404, the assistance module associated with the high-pressure shaft enters into action to communicate the high-pressure power to the low-pressure shaft before, in a final step 406, the power taken off by the low-pressure shaft is adjusted based on this high-pressure power to reach the additional power requested by the assistance mode.

Note that the invention has an application in the internal hybridization of turbomachines whatever the number of electric machines mounted on the propulsion system and the type of turbomachine, such as a hybrid turbofan, a hybrid turboprop or a hybrid helicopter turbomachine.

1. A method for managing the power transitions between a generation mode and an assistance mode in a turbomachine having a high-pressure shaft driving a high-pressure electric machine and from which a high-pressure power is taken off and a low-pressure shaft driving a low-pressure electric machine and from which a low-pressure power is taken off, the generation mode corresponding to a predetermined sharing of power between the high-pressure power and the low-pressure power and the assistance mode corresponding to a request for injection of an additional power into the high-pressure shaft or the low-pressure shaft,
wherein to reach the requested additional power, when the high- or low-pressure power takeoff is interrupted and the high- or low-pressure electric machine respectively driving the high- or low-pressure shaft whose takeoff is interrupted enters motor mode, the remaining taken-off power from the high- or low-pressure shaft in generator mode is adjusted based on the injected high- or low-pressure power coming from the high- or low-pressure electric machine that has entered motor mode.

2. The method for managing power transitions as claimed in claim 1, wherein if the high- or low-pressure electric machines have different dynamic ranges, the injection of the requested additional power is done by adapting the dynamic range of the takeoff of the remaining taken-off high- or low-pressure power.

3. A turbomachine having a high-pressure shaft from which a high-pressure power is taken off and a low-pressure shaft from which a low-pressure power is taken off, a control module receiving power setpoints from an ECU and power converters associated with high- and low-pressure electric machines respectively mounted on the high- and low-pressure shafts, a generation mode corresponding to a predetermined sharing of power between the high-pressure power and the low-pressure power and an assistance mode corresponding to the injection of an additional power into the high-pressure shaft or the low-pressure shaft, wherein to reach the requested additional power, the control module is configured so that, when the takeoff of high- or low-pressure power is interrupted and the high- or low-pressure electric machine respectively driving the high- or low-pressure shaft whose takeoff is interrupted enters motor mode, the remaining taken-off power from the high- or low-pressure shaft in generator mode is adjusted based on the injected high- or low-pressure power coming from the high- or low-pressure electric machine that has entered motor mode.

4. The turbomachine as claimed in claim 3, wherein the control module further comprises assistance modules configured to add the injected high- or low-pressure power to the remaining taken-off high- or low-pressure power and a selecting module configured to select the taken-off powers coming from the assistance modules.

5. The turbomachine as claimed in claim 4, wherein each of the assistance modules includes an adder and an adapting module-having a transfer function F1, F2 to adapt the dynamic range of the remaining taken-off high- or low-pressure power according to the respective dynamic ranges of the high- and low-pressure electric machines.

6. The turbomachine as claimed in claim 5, wherein the transfer functions are equal to 1 if the high- and low-pressure electric machines have the same dynamic range.

7. The turbomachine as claimed in claim 5, wherein the transfer functions are phase delays if the dynamic range of the electric machine that enters motor mode is slower than the one that remains in generator mode.

8. The turbomachine as claimed in claim 5, wherein the transfer functions are phase advance functions if the dynamic range of the electric machine that enters motor mode is faster than the one that remains in generator mode.

9. The turbomachine as claimed in claim 3, consisting of an aeronautical turbomachine such as a hybrid turbofan, a hybrid turboprop or a hybrid helicopter turbomachine.
